(19) United States
(12) Patent Application Publication
(10) Pub. No.: US 2020/0206659 A1
(43) Pub. Date: Jul. 2, 2020

(54) FILTER MODULE, FILTER MODULE SYSTEM, AND METHOD FOR BINDING PARTICLES OF A MATERIAL MIXTURE

(71) Applicant: FACHHOCHSCHULE KIEL, Kiel (DE)

(72) Inventor: Jan Henrik WEYCHARDT, Flensburg (DE)

(21) Appl. No.: 16/467,606

(22) PCT Filed: Dec. 6, 2017
(86) PCT No.: PCT/EP2017/081724

§ 371 Date: Jan. 24, 2020

(30) Foreign Application Priority Data
Dec. 9, 2016 (DE) 10 2016 014 657.5
Sep. 7, 2017 (DE) 10 2017 215 813.1

(51) Int. Cl. B01D 29/70; B01D 35/26; B01D 29/52; B01D 29/11

(52) U.S. Cl. CPC B01D 29/705; B01D 29/118; B01D 29/52; B01D 35/26

(57) ABSTRACT

A filter module for binding particles from a particle-laden material mixture, in particular from an aerosol or from a particle-laden fluid, is provided. The approach of deforming an open-pored medium, in particular periodically, by means of a relative motion relative to a deformation unit and in this way producing a motion of the material mixture to be filtered through the open-pored medium is provided, whereby the material mixture is filtered by the open-pored medium. According to an embodiment, a cylindrical open-pored medium is introduced, together with a deformation unit, into a cylindrical housing and said open-pored medium can be deformed geometrically, in particular periodically, preferably at least along the cylinder axis of the housing and/or in the radial direction, by means of the deformation unit. According to an embodiment, a plurality of filter elements are arranged adjacent to each other with respect to the longitudinal extent thereof and are deformed with respect, to the longitudinal extent thereof periodically, preferably in an undulating manner, in particular substantially sinusoidally, wherein the deformation motions of the filter elements are phase-shifted with respect to each other.

The entire content of priority applications DE 10 2016 014 657.5 and DE 10 2017 215 813.1 is hereby incorporated into the present application by reference.

The invention relates to a filter module for binding particles, a filter module system consisting of at least two such filter modules, as well as a method for binding particles of a material mixture. The invention is particularly suited to filtering fine dust from a particle-laden aerosol or fluid.

The filtering of minute particles is problematic as they behave similarly sluggish in air or other medium as steel balls do in honey even at the slowest flow velocities they do not have enough inertia to abut against and adhere to a filter fiber when deflected at same. Adhesion effects or Brownian motion, for example, then need to become effective at the point of inertia. Because these are different physical effects, there is no filter action which is equally effective for each particle size.

One application for such filtering is removing micro-plastic particles from the seas, which is a global and very urgent problem from an ecological point of view.

So-called tangential flow filtration, also known as cross-flow, tangential flow or transverse filtration, is known from the prior art.

In transverse filtration, a suspension to be filtered; i.e. a heterogeneous material mixture of a liquid and particles distributed therein, is directionally pumped at a relatively high speed parallel to a membrane or a filter medium and the filtered mixture, also called filtrate, is passed transverse to the direction of flow until the membrane is clogged.

While in ordinary filters the solids to be separated are recovered as filter cake, the solid can only be concentrated in transverse filtration to the extent of the suspension still being able to be pumped. The filtrate is free of solids in both cases. The part of the liquid flow not passing through the membrane is called the retentate.

In the prior art, the unfiltered product is furthermore circulated through the capillaries of a filter using a circulation pump until the turbidity in the retentate is so concentrated that emptying and cleaning becomes necessary. Oscillating filter movements are currently only known for cleaning a dust filter as shown for example by DE 10 2010 026 486 A1.

Further known from the prior art are the principles of a peristaltic pump for medical applications without filters such as in DE 699 15 869 T2, or peristaltic hose pumps with separate filters as shown in U.S. Pat. Nos. 8,211,047 B2 or 6,190,569 B1.

Also known are combining passive filter methods with pumps as well as natural phenomena which likewise suggest drawing on bionics to technically reproduce a transverse filtration such as in plankton-filtering animals, e.g. fish.

The invention is based on the task of providing an improved filter module, an improved filter module system and an improved method for binding particles of a material mixture.

This task is solved by the filter module, the filter module system and the method according to the independent claims. Advantageous embodiments of the invention are contained in the subclaims.

The invention is based on the approach of deforming, in particular periodically, an open-pored medium in a housing or within a wall by a relative movement vis-à-vis a deformation unit, and by so doing generating a movement of the material mixture to be filtered through the open-pored medium. Doing so effects a high contact probability between the particles of the material mixture and the open-pored medium and the material mixture filtered through the open-pored medium.

This fundamental concept of the invention is further developed by two design concepts which will be described below. Features and properties of the first design concept can thereby also be carried over to the second design concept and vice versa, provided that doing so is technically feasible and sensible.

The filter module can in principle be of any shape. Generally defined as the axis of the filter module is the desired direction of flow between the inlet and outlet. The filter module is preferably deformed transversely to this axis, preferably periodically and further preferably sinusoidally, in the direction of flow. The desired degree of deformation can be defined as a certain percentage of the respective local transverse extension; i.e. thickness, of the open-pored medium. This then corresponds to the desired degree of deformation of each individual pore in the open-pored medium.

The filter module according to the invention or the system of multiple inventive filter modules respectively can be utilized in the most diverse range of industrial applications in the filtering of particularly fluids and/or aerosols and the binding of particles.

Preferential fields of application of the invention are fields in which high particle volumes or large concentration gradients are to be expected. With no further concentration, the continuous outflow of the retentate gives rise to an equilibrium value which can be maintained for a long period of time.

This type of particle binding has great importance to applications such as within medical technology, clean room technology, nanotechnology and offshore technology. Specific applications arise for example in beverage filtration, dialysis, microfiltration, ultrafiltration, nanofiltration, gas separation, pervaporation, reverse osmosis, diafiltration and the like.

Overall, the invention achieves simple and reliable filtration of the material mixture.

The inventive filter module and the inventive method in particular represent an effective solution principle for the above-mentioned global problem of contamination of the oceans by micro-plastic particles.

The filter module according to the first design concept of the invention exhibits a substantially cylindrical housing into which a substantially cylindrically shaped open-pored medium is introduced, which is designed to hold a material mixture, in particular a sponge medium, an open-pored foam and/or a filter medium for a material mixture, through which in particular a multi-phase material mixture, preferably an aerosol and/or fluid, can flow. The filter module furthermore comprises at least one inlet and at least one outlet for a material mixture.

In one preferential implementation of the first design concept of the invention, an open-pored foam is used as the medium. The connections between the pores therein are smaller than they are themselves. In particular, each filter pore is then preferably reduced once per cycle to a volume approaching zero, thus releasing the particle-laden material mixture it holds to the next filter pore. Particle adhesion and thus a filtering of the material mixture thus already ensues with high probability from the principle of inertia.

In one preferential implementation of the first design concept of the invention, the medium is elastic and/or compressible. In particular, the medium can be a substrate or a gel.

The medium can also be cleanable, e.g. by means of a liquid wetting it.

The open-pored medium substantially forms a cylinder, preferably a hollow cylinder. In one preferential implementation of the first design concept of the invention, the open-pored medium forms at least two, preferably at least four, further preferentially at least six cylinder sectors (i.e. “cake slices,” the height of which extend along the cylinder axis of the medium). The number of cylinder sectors does not, however, have an upper limit. Preferably, the cylinder sectors put together take the shape of the cylinder, or hollow cylinder respectively, of the medium accommodated in the housing.

In a further preferential implementation of the first design concept of the invention, adjacent cylinder sectors are in each case sealed against each other with respect to the material mixture, preferably by a shell.

It is however also possible for the open-pored medium to only form one single cylinder sector which thereby covers a circumferential angle of 360 degrees. Preferably, said one cylinder sector comprises a material mixture-tight wall which radially extends in a plane through the cylinder axis of the medium from its inner to its outer peripheral surface on one side of the cylinder. In other words, this arrangement of the open-pored medium would also result if all the cylinder sectors in the above-described arrangement of multiple cylinder sectors were joined together by omitting all but one of the shell parts separating said cylinder sectors.

This arrangement prevents circumferential flow around the cylinder axis when the material mixture is drawn through the open-pored medium, particularly when the deformation unit is a screw or comprises an eccentric. In this case, therefore, a plurality of cylinder sectors are not “connected in parallel” to increase performance but rather the open-pored medium is internally divided in the single cylinder sector to increase efficiency.

An open-pored medium within the meaning of the invention may also be a nano-porous particle filter or a compressible gel, preferably an aerogel or a molecular lattice. A molecular lattice is thereby preferably a spatial molecular lattice structure preferably a carbon “soccer ball-shaped” molecule arbitrarily enlarged periodically which has specific chemical, physical and/or biological characteristics, in particular for binding or chemically modifying the material mixture to be filtered.

Particles, particulates or small solids denote dispersed materials which differ from a surrounding continuous medium by a phase interface, e.g. the solid or liquid elements of aerosols, the solid elements of suspensions, the particles of powders, as well as drops of liquid in emulsions.

The geometry and the material of the open-pored medium is preferably matched to the geometry and the material properties of the particles to be bound so that the mixture of material is well maintained in the medium temporarily or permanently, preferably in the open-pored regions. The open-pored medium is preferably geometrically adapted to the cylindrical housing so that the outer skin of the open-pored medium or a shell surrounding the medium can lie against the inner wall of the housing.

The open-pored medium is preferably introduced into the housing so as to be compressible and relaxable along the cylinder axis of the housing and/or in the radial direction.

According to the first design concept of the invention, the filter module furthermore comprises at least one deformation unit, wherein the open-pored medium is geometrically deformable by the deformation unit, preferably at least along the cylinder axis of the housing and/or in the radial direction. In one preferential embodiment of the first design concept of the invention, the at least one deformation unit is movable relative to the housing and the medium.

In the relative movement, the at least one deformation unit can be at rest and the housing and the medium moving. Preferential, however, is the housing and the medium being at rest and the at least one deformation unit moving.

The deformation of the open-pored medium preferably ensues mechanically, e.g. by a shaft with an eccentric, electromagnetically, e.g. by magnetizable body, pneumatically and/or hydraulically, e.g. by hoses. Using mass to deform the open-pored medium by gravity is also possible. Accordingly, in one preferential implementation of the first design concept of the invention, the deformation unit is a shaft, a screw or a hose body and/or comprises at least one eccentric.

Flow directions can also be influenced by targeted deformations of the medium. The deformation thereby preferably ensues periodically but is not limited thereto.

During the deformation, the open-pored medium is geometrically modified by the deformation unit itself and also in porosity. Figuratively speaking, this is for example comparable to rolling out batter/dough, wherein a roll is rolled on the open-pored medium along the cylinder axis and in the radial direction and the medium can relax again subsequent the rolling process.

The deformation unit can be of different design. In one preferential implementation of the invention's first design concept, the deformation unit exhibits a helical geometry, e.g. in the form of a shaft along the cylinder axis of the housing which is configured to act in deforming manner on the medium and thereby move the material mixture through the medium, into the medium and/or out of the medium.

By the rotation about the cylinder axis in the housing, the deformation unit thereby preferably acts on the open-pored medium so as to produce a directed conveying process for the material mixture in a direction of the cylinder axis.

The deformation unit is preferentially enclosed by a gas-tight shell with respect to the material mixture, particularly when the deformation unit comprises an eccentric.

The first design concept of the invention further relates to a method in which a material mixture, e.g. an aerosol or fluid comprising particles to be bound, is continuously moved unidirectionally through or respectively into an open-pored medium, wherein individual particles, preferably defined by their size, permeate the medium or are held in same respectively.

Particles can thereby be held permanently or temporarily by different pore geometries. Since the pore geometries change with the respective deformation, particle migration can occur up to the point at which the pore geometry optimally absorbs/holds a particle.

This process can also ensue with a multi-layered structure to the open-pored medium, preferably with a geometry to the open-pored medium which is rotationally symmetrical to the cylinder axis and further preferably having different pore structures which are movable relative to one another from one layer to the next.

Open-pored media with irregular or statistical distribution of the pores and/or pore sizes in relation to particle size distribution can furthermore be used. This occurs in particular under the assumption that both the particles as well as the pores are normally distributed on a logarithmically scaled abscissa. In order to optimize the filter/adhesive effect, the mean values in particular are matched to one another such that the particles do not on the one hand plug the medium close to the inlet yet, on the other hand, the probability of collision and thus adhesion over a passage is at a maximum.

The intake and conveying process for the material mixture preferentially ensues in the direction of flow from an inlet to an outlet of the respective module. In the intake process, the material mixture enters at a location of the open-pored medium at which a cylinder sector changes from a compressed state to a relaxed state.

In a further preferential implementation of the first design concept of the invention, the inlet and/or the outlet for the material mixture is in each case set in a cover having at least one opening which preferably moves around the cylinder axis with the deformation unit relative to the open-pored medium and the housing. Further preferably, the cover can in each case be coupled to the deformation unit.

The shape of the opening is preferably sinusoidal or crescent-shaped and is further preferably adapted to the geometric inlet/outlet conditions of the dynamically deforming open-pored medium geometry in order to prevent backflow of the material mixture.

The cover can also be configured as a grid or mesh if the location of the inlet is definable for example by utilizing an antechamber and the return flow is collected for all the other sectors and returned to the inlet location again.

In one preferential embodiment, the outlet of the filter module comprises a coupling, in particular a claw coupling, for preventing backflow. Preferably, a drive can thereby be coupled, a plurality of modules can be kept coupled via the respective shafts, and a torque can be transmitted from one shaft to the next shaft in the same rotational direction. Thus, it is possible to change a filter module from an assemblage of filter modules by simply removing and inserting the filter module.

The method according to the first design concept of the invention for binding particles of a material mixture in at least one medium using a filter module comprises at least the following steps:
a. providing the material mixture at one of the inlets of the housing;
b. drawing in the material mixture by means of the at least one deformation unit being moved relative to the housing and the medium;
c. binding the particles in the medium;
d. pumping out the material mixture at least partially freed of particles at one of the outlets;
e. terminating or continuing with f.;
f. replacing the medium with another medium;
g. continuing with a.

In one preferential embodiment of the method for binding particles of a material mixture, a preferably sine wave-like deformation of the open-pored medium is generated by a pumping motion, preferentially in the direction of the cylinder axis, by the action of the deformation unit on the open-pored medium. In addition, an advancing of the material mixture along the cylinder axis is generated by a preferentially helical rotation about the cylinder axis similar to a corkscrew.

In a filter module system according to the first design concept of the invention of at least two filter modules, the filter modules according to the invention's first design concept are connected in series such that in each case one outlet of a filter module is connected to an inlet of the next filter module in releaseable, force-conveying and material mixture-conveying manner. Filter performance can in this way be multiplied by the use of multiple filter modules in accordance with the first design concept of the invention.

The method according to the first design concept of the invention for binding particles of a material mixture in at least one medium using a filter module system comprises at least the following steps:
a. providing the material mixture at an inlet of the first filter module;
b. pumping out the material mixture from each filter module at a respective outlet and drawing in the material mixture into the respective next filter module at a respective inlet by means of the at least one deformation unit and/or the covers of each filter module being jointly moved relative to the housing and the medium of the respective filter module;
c. binding the particles in each filter module in the respective medium;
d. pumping out the material mixture at least partially freed of particles at an outlet of the last filter module;
e. terminating or continuing with f.;
f. replacing the medium in at least one filter module with another medium;
g. continuing with a.

The filter module according to the second design concept of the invention for binding particles from a particle-laden material mixture, in particular from an aerosol or from a particle-laden fluid, comprises:
a plurality of filter elements, wherein each filter element is filled with a preferably open-pored medium, in particular a sponge medium, an open-pored foam, a gel, a molecular lattice and/or a filter medium for the material mixture, and surrounded by a wall impermeable to the material mixture and to the medium and having at least one inlet and at least one outlet for the material mixture, wherein the material mixture can flow through each filter element in substantially the direction of its longitudinal extension from the at least one inlet to the at least one outlet, and
a deformation unit, wherein the filter elements and in particular the medium therein are deformable by the deformation unit.

With respect to the medium, reference is made to the respective explanations provided for the first design concept of the invention, which apply equally to the second design concept.

According to the second design concept of the invention, the filter elements are arranged side by side with respect to their longitudinal extension and respectively adjacent filter elements are connected to each other along their respective facing walls running substantially parallel to their longitudinal extension.

A connection thereby refers to a mechanical, in particular materially bonded, connection, preferably by means of gluing or welding the wall parts together, which prevents a relative movement of the connected wall parts against each other.

The use of multiple adjacently arranged filter elements which are connected together yet still prevent a flow of the material mixture through their walls from one filter element into an adjacent filter element at the connection points is advantageous so that no flows transverse to the conveying direction occur within the filter module.

Preferably, the filter elements have substantially the shape of elongated cuboids or substantially the shape of elongated cylinders, the lateral surfaces of which may be somewhat “flattened” at the connection points with the respective adjacent filter elements.

According to the second design concept of the invention, the deformation unit is moreover designed to deform the filter elements with respect substantially to their longitudinal extension periodically, preferentially in an undulating manner and particularly preferentially substantially sinusoidally, wherein the deformation motions of the filter elements are phase-shifted relative each other.

The phase offset can thereby occur, in particular also in fluxionary manner, on a single filter element; i.e. the respective filter element is subjected to deformation motions having different phases at different points transverse to its longitudinal extension, wherein the phase offset between these deformation motions can in particular change continuously. This serves in the reciprocal compensating of pulsations.

During the deformation, the medium is geometrically modified by the deformation unit itself and potentially also in porosity. Figuratively speaking, this is for example comparable to rolling out batter/dough, wherein a roll is rolled on the medium along the longitudinal extension of the filter element and the medium can relax again subsequent the rolling process. The deformation unit thereby preferably acts on the medium so as to generate a directed conveying process for the material mixture in the direction of the longitudinal extension of the filter element.

A substantially constant pumping effect is achieved with the filter module according to the second design concept of the invention. A particularly uniform pumping effect is to be expected with purely sinusoidal waves.

In one preferential implementation according to the second design concept of the invention, the deformation motions of the filter elements are phase-shifted relative each other such that a periodic, preferably undulating, deformation motion results on the adjacently arranged filter elements along a series of locations at the same height with respect to the longitudinal extension of the filter elements.

In particular, the phases between adjacent filter elements each have the same; i.e. a constant, offset.

Due to the periodic and preferably undulating deformation motions both in the direction of the longitudinal extension of the filter elements as well as transversely thereto, periodic movements, particularly waves and in particular sinusoidal waves which overlap ensue in both directions. Taken as a whole, the wavefronts migrate diagonally to the longitudinal extension of the filter elements.

In a further preferential implementation according to the second design concept of the invention, at least one inlet and/or one outlet of at least one filter element on the surface of the filter element exhibits an elongated shape with a longitudinal and/or transverse extension in a direction between the direction running transverse to the longitudinal extension of the filter element and the direction of wavefront propagation, preferably substantially at an angle bisector between said two directions.

Such a position of the inlets and outlets is advantageous since, on the one hand, mechanical impacts occur with the deformation unit phase-shifted transverse to the longitudinal extension of the filter elements and, on the other hand, maximum hydraulic pulsations occur in the longitudinal extension of the filter elements; i.e. in the direction of flow of the material mixture. Conversely, only slight mechanical and hydraulic irregularities are to be expected when selecting inlets and outlets between said two directions.

In a further preferential implementation according to the second design concept of the invention, the filter module further comprises at least one securing device, in particular at least one rocker, by means of which the wall parts of the filter element, particularly in the area of the filter element inlets, are fixable, particularly restricted in mobility, with respect to at least one stationary point external of the filter module.

Such a securing device is then particularly advantageous when the deformation unit would shear the filter element in the direction of its longitudinal extension. The securing device then holds the wall of the filter element in position.

In a further preferential implementation according to the second design concept of the invention, the deformation unit comprises a plurality of rollers with at least partially different diameters which are configured to roll along the filter elements substantially along the longitudinal extension of said filter elements and thereby deform the filter elements to at least partially different degrees of deformation.

The desired deformation can thereby be achieved at low friction. The different diameters of the rollers produce the periodic, in particular undulating, deformation motion when rolling.

In an alternative implementation, vertically acting actuators are distributed over the surface of the filter elements, same generating the deformations without moving across the surface of the filter elements. The actuators can in particular be moved mechanically, electrically or hydraulically or by means of another drive principle. In this implementation, no or only slight shearing of the filter elements is to be expected such that the above-cited securing device is not strictly necessary. Preferably, the actuators are coupled hydraulic or electromechanical linear drives which generate the desired contour point-by-point.

In one preferred variant of this implementation, the plurality of rollers are arranged on a plurality of in particular parallel axes. The rollers can thus run at individual speeds.

Preferentially, at least one first axis and a second axis adjacent to the first axis are thereby arranged parallel to one another, and for a pair comprising a first roller arranged on the first axis and a second roller directly adjacent to the first roller and arranged on the second axis, the distance separating the two axes is less than the sum of the radius of the first roller and the radius of the second roller.

This is preferably achieved in that the rollers are axially offset from each other between adjacent axes and can thus “intermingle.” In so dong, the first and the second axis can be at a very small distance to each other so that the rollers can be arranged on the axes very densely and in large numbers, which in turn results in a large bearing surface on the filter elements.

In a further preferential implementation according to the second design concept of the invention, the plurality of filter elements is arranged in an overall hollow cylindrical shape.

Due to the “endless” arrangement of the filter elements in the form of a cylinder surface, the deformation unit, inasmuch as it is moved relative to the filter elements, does not have to be moved back to the beginning of said surface after a complete movement over the surface of the filter elements.

In one preferred variant of this implementation, the deformation unit likewise exhibits a hollow cylindrical shape and contacts the plurality of filter elements on their inner or outer side, and the filter elements and deformation unit are configured to rotate relative to one another.

This results in a compact, mechanically stable and relatively easily implemented design to the filter module. Preferably, the filter elements are at rest and the deformation unit is rotated relative thereto so that the material mixture to be filtered does not transfer to the rotating filter elements or the filtered material mixture does not have to be purged from them respectively. Alternatively, however, it is also possible for the deformation unit to be at rest and the filter elements rotate relative thereto.

The filter module thereby preferably has at least two filter elements arranged one behind the other with regard to their longitudinal extension and the at least two filter elements are connected together along the respective parts of their walls extending substantially transversely to their longitudinal extension and facing one another. These wall parts are preferably in each case a front and a rear end face of the respective filter element seen in the direction of the longitudinal extension.

In particular, a first number of filter elements are arranged side by side with respect to their longitudinal extension in the axial direction of the hollow cylindrical shape in which the filter elements are arranged and a second number of filter elements are arranged one behind the other with respect to their longitudinal extension in the circumferential direction of the hollow cylindrical shape. The second number then thus amounts to at least two.

In other words, a first number of adjacent rings of filter elements, each consisting of a second number of filter elements lying one behind the other, are arranged on a cylinder surface, whereby each filter element is connected to its neighbors at the contact surfaces.

It is thereby preferential for the number of periods of the periodic and preferably undulating deformation of the filter elements to be substantially greater with respect to their longitudinal extension by way of the deformation unit during a rotation of the deformation unit relative to the filter elements, particularly greater by at least one, than the number of hollow cylindrical filter elements arranged one behind the other with respect to their longitudinal extension, thus the second number. As a result, the material mixture flow through the filter elements is pulsation-free.

In one preferred variant of that implementation of the invention according to the second design concept in which the deformation unit has rollers arranged on axes and the arranged hollow cylindrical filter elements rotate relative to the likewise hollow cylindrical deformation unit, wherein the deformation unit contacts the inner side of the plurality of filter elements, a central roller is arranged on the inner side of the deformation unit which is designed to press at least one roller on each respective axis outward to the filter elements.

The axes and thus also the other rollers arranged thereon are in this way pressed outwardly. The central roller itself can also rotate and thereby frictionally drive the rollers both to rotate about the axis of the central roller as well as to rotate about their own axis. The filter module then has similar kinematics as a planetary gear with fixed internal gear.

Alternatively, however, the central roller can also be fixed and the rollers can be positively driven via the axes both to rotate about the axis of the central roller as well as to rotate about their own axis.

In a further preferred implementation according to the second design concept of the invention, the deformation unit is configured to deform at least one part of the walls of the filter elements running substantially parallel to the longitudinal extension of the filter elements along which two adjacent filter elements are connected together. Doing so thus enables each element of the deformation unit in contact with the filter elements to simultaneously deform two filter elements, thereby reducing the structural complexity.

Preferably, the deformation unit is configured to deform all the parts of the walls along which adjacent filter elements are connected. Further preferably, the deformation unit is also configured to deform the outer walls of the outward filter elements running substantially parallel to the longitudinal extension of the filter elements.

In one method according to the second design concept of the invention for binding particles from a particle-laden material mixture, in particular from an aerosol or from a particle-laden fluid, with a filter module according to the second design concept of the invention, the material mixture is first provided at least at one inlet of at least one filter element of the filter module. The medium in the filter element is deformed by the deformation unit, whereby the material mixture is drawn into the filter element at the at least one inlet and the material mixture flows through the filter element substantially in the direction of its longitudinal extension from the inlet to an outlet, particles from the material mixture thereby being bound in the medium and the material mixture at least partially freed of particles pumped out at the outlet.

Further advantages, features and possible applications of the first and second design concept of the present invention will become apparent from the following exemplary description in conjunction with the figures. Shown are:

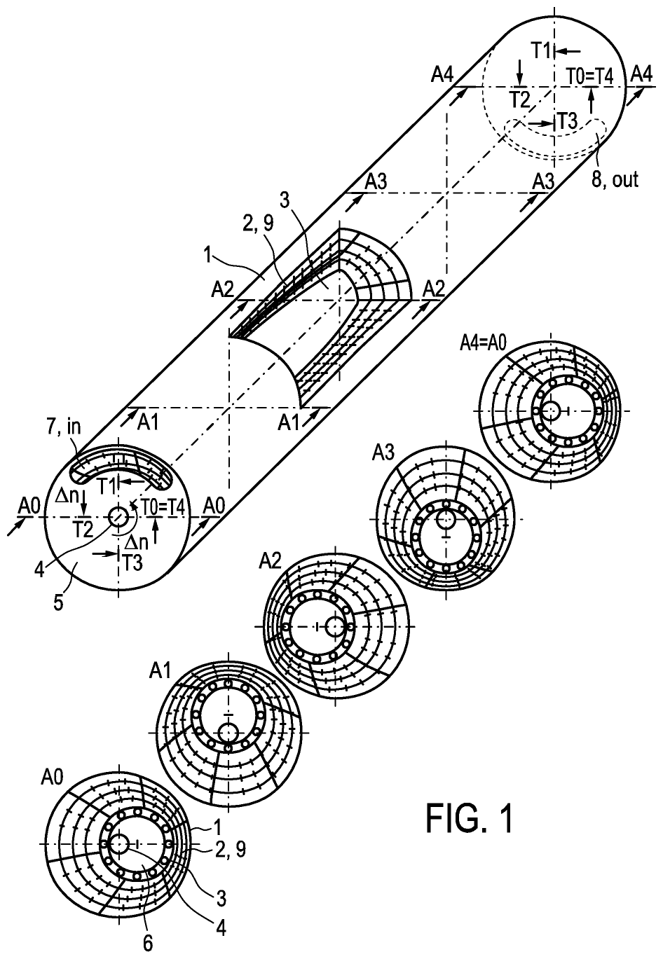

FIG. 1 an exemplary embodiment of a filter module according to the first design concept of the invention in a perspective partially cutaway view along with five sectional images A0 to A4 seen axially from above as a sectional image at various points through the cylindrical housing;

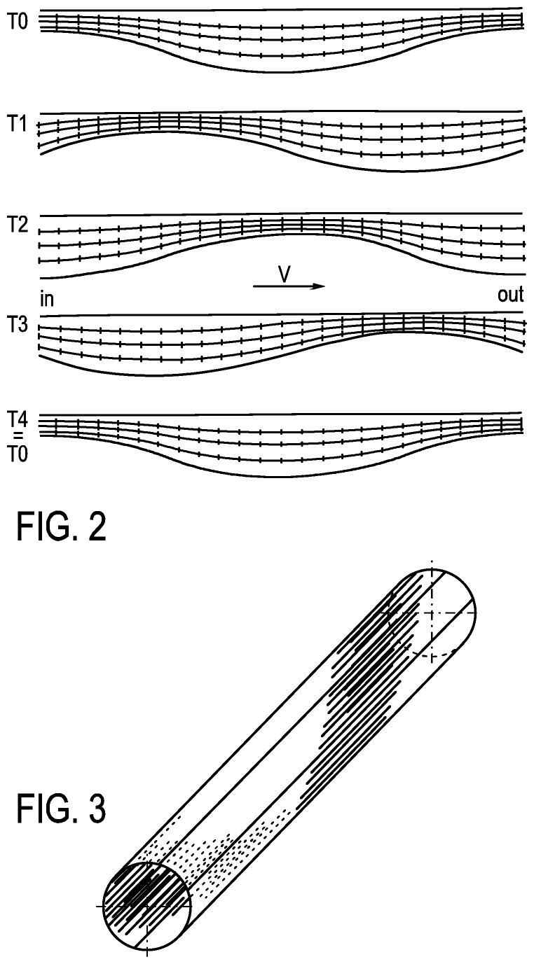

FIG. 2 an exemplary embodiment of the section in the main flow direction through the filter module according to FIG. 1 for a cylinder sector with open-pored medium movement patterns T0 to T4;

FIG. 3 a schematic, perspective progressive image of the pumping process for the cylinder sectors of a filter module according to FIG. 1;

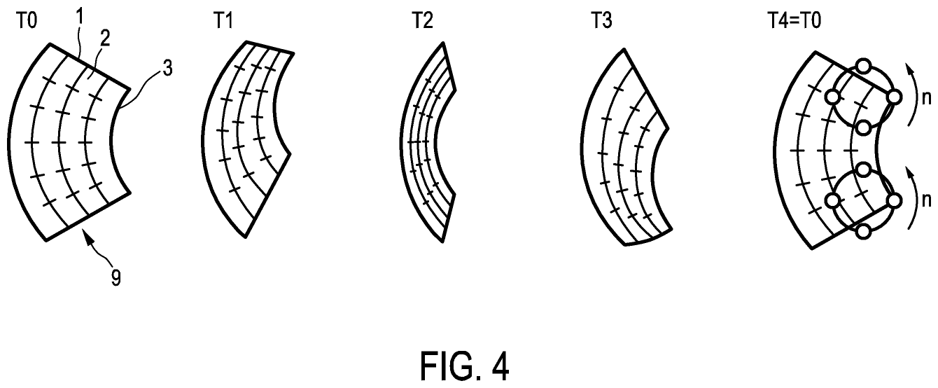

FIG. 4 movement patterns T0 to T4 for a single cylinder sector in the filter module according to FIG. 1;

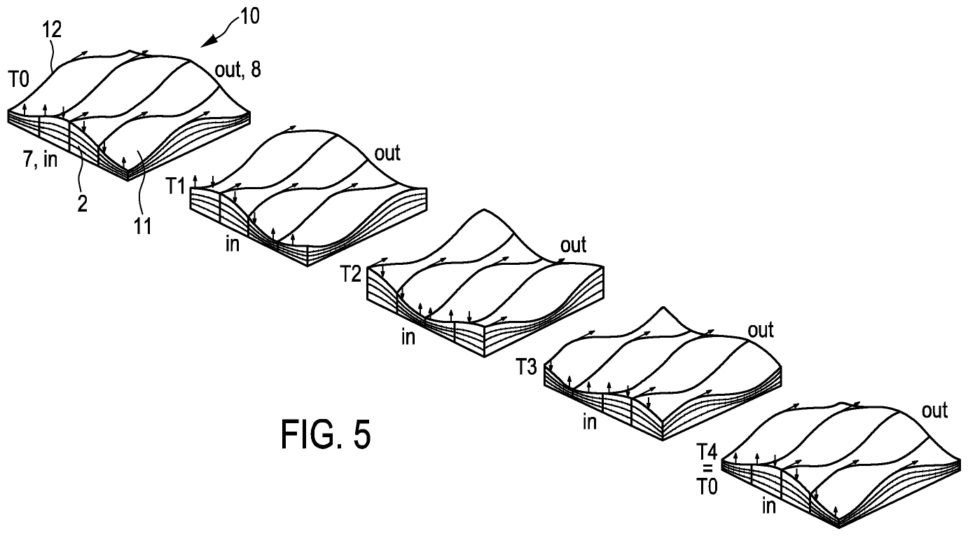

FIG. 5 a perspective view of a filter module according to the second design concept of the invention in five different deformation states over the course of the periodic undulating deformation motion;

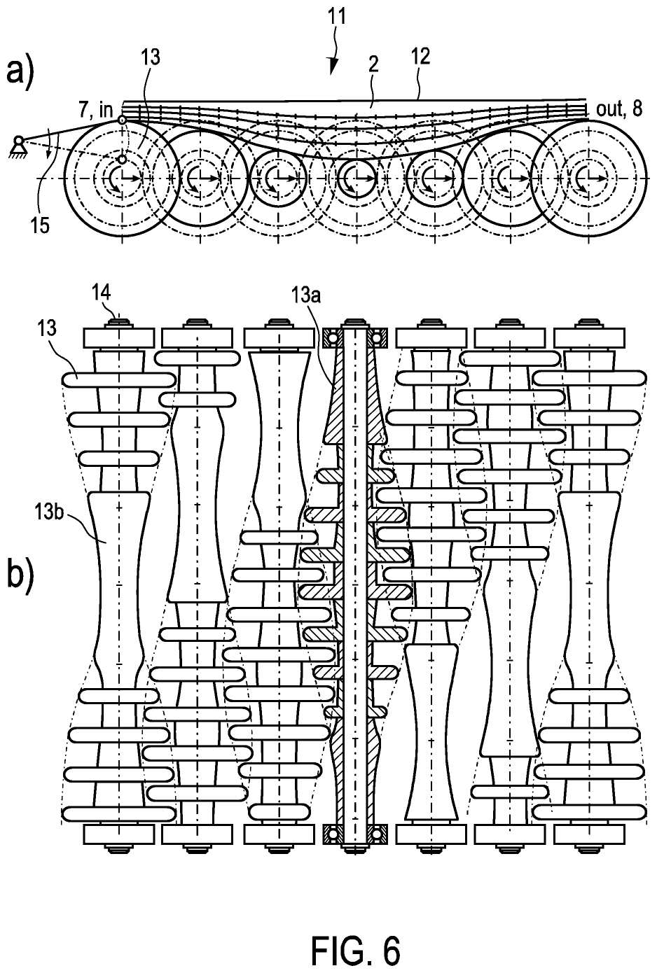

FIG. 6 an exemplary embodiment of a deformation unit of a filter module according to the second design concept of the invention with a plurality of rollers arranged on parallel axes;

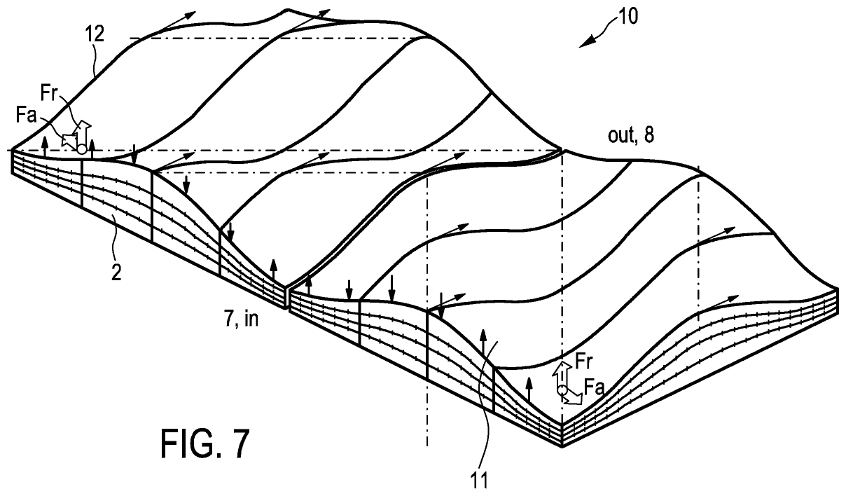

FIG. 7 a depiction of the force compensation in a filter module according to FIG. 5;

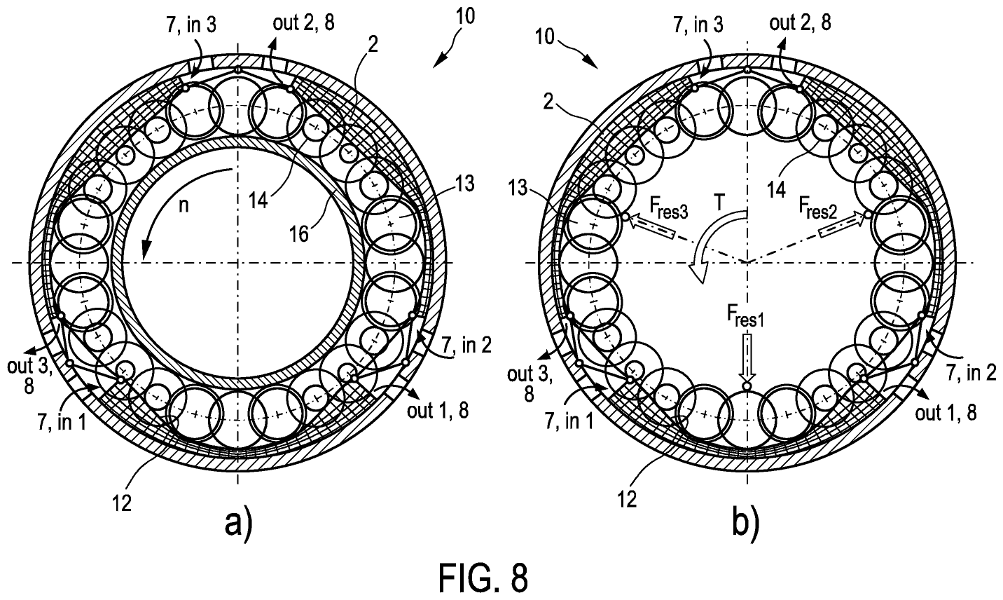

FIG. 8 an exemplary embodiment of a filter module according to the second design concept of the invention with respective hollow cylindrical filter elements and a deformation unit which rotate relative to each other;

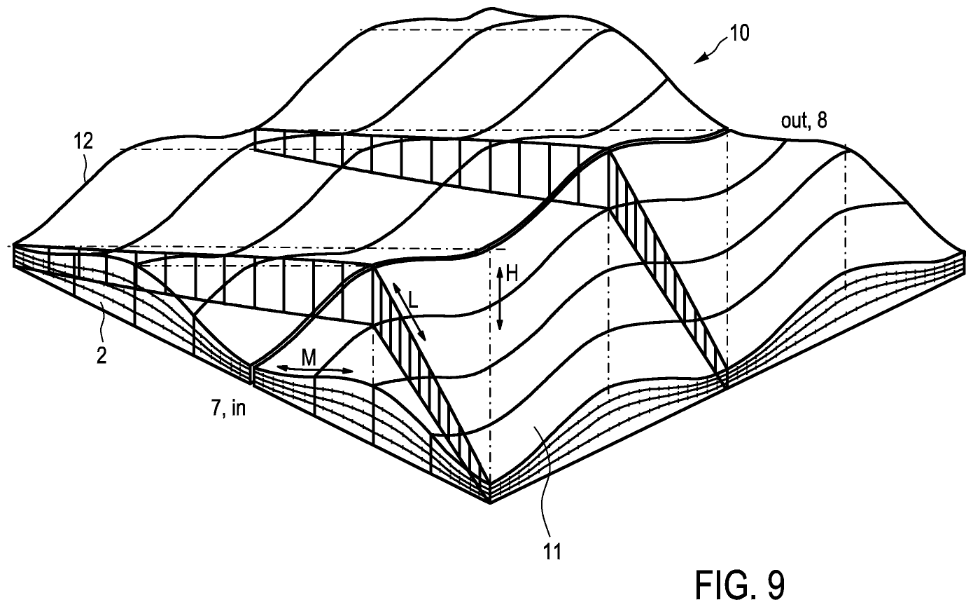

FIG. 9 s depiction of the possible positions of the inlets and outlets of the filter elements in a filter module according to FIG. 5;

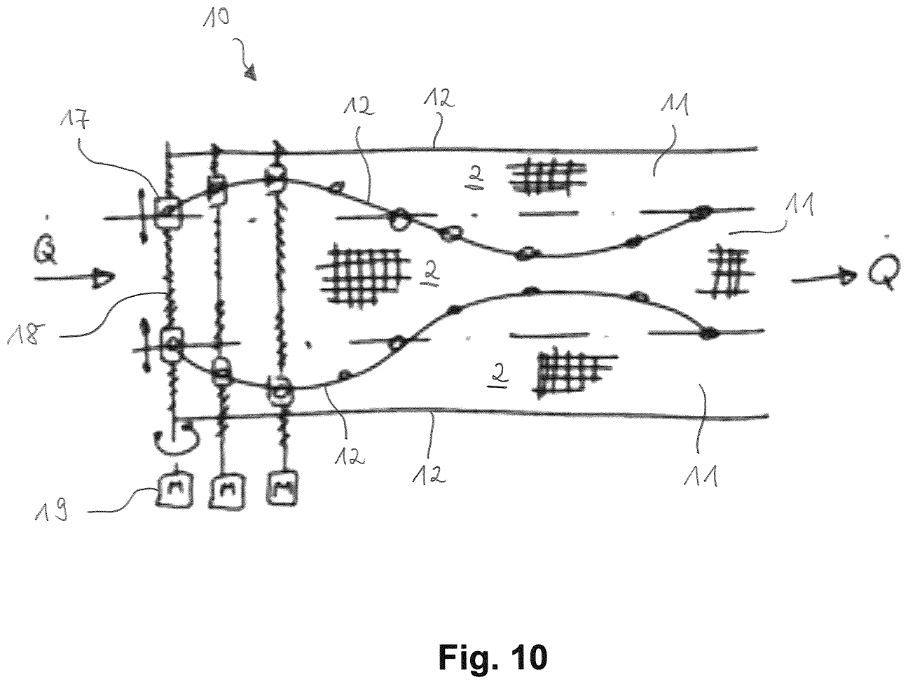

FIG. 10 a further exemplary embodiment of a filter module according to the second design concept of the invention, wherein the walls connecting the filter elements are deformed.

FIG. 1 shows the steps of a continuous material mixture conveying process in the exemplary embodiment of a filter module according to the first design concept of the invention.

A medium 2 (e.g. an open-pored sponge) divided into a plurality (n=6 here) of circular cylinder sectors 9 separated in gas-tight manner from one another transverse to the direction of flow is fixed in a fixed cylindrical housing 1 accommodating flow in the axial direction. Each of the circular cylindrical sectors 9 is to be successively deformed by a deformation unit 4, 6 in the manner shown by A0 to A4 in FIG. 1 and thus exert its own conveying action on the material mixture.

The inner sides of the circular cylinder sectors 9 rest on a flexible shell 3 which, in the exemplary embodiment in the form of a rotating helix, forces the sinusoidal geometric progressions as shown in FIG. 2. The drive of the helical rotation is the deformation unit 4, 6, here shaft 4, which rotates with two covers 5 relative to the housing at rotational speed Δn. The “in” inlet 7 and “out” outlet 8 are situated in the covers 5. They for example ensure intake and expulsion of the material mixture in the proper circulatory state.

On the shaft 4 is a plurality of preferably circular disc-shaped, phase-shifted and radially extending eccentrics 6 which are rotatably fixed to said shaft 4 axially adjacent one another and preferably without gaps. The deformation unit 4, 6 consisting of the shaft 4 and the eccentrics 6 thus approaches a helical geometry.

The generating of the helical rotation is shown in sectional views A0 to A4. Shown in each case here is the eccentric 6 of the deformation unit 4, 6 attached to the respective location on the shaft 4 corresponding to the locations indicated in the perspective representation of the cylinder. The more closely the helix is approximated by the plurality of eccentrics 6, the more continuous is the conveying effect of the material mixture and the binding of particles in the medium 2. The eccentrics 6 travel in the flexible shell 3 with little friction. To that end, a bearing, in particular a roller bearing, is preferably arranged between each eccentric 6 and the shell 3.

Considering only that circular cylinder sector 9 located on the far right in section A0 in sections A0 to A4 shown in FIG. 1, and theoretically supplementing with all the states of the medium 2 between depicted sections A0 to A4, results in images T0 to T4 from FIG. 2 in a tangential view from above.

The medium 2 preferentially has low material damping and high fatigue strength. An optional effect-enhancing fluid of the material mixture should thereby have a surface tension which does not unnecessarily inhibit the expanding of the medium 2.

FIG. 2 shows an example of the progression of the individual chronological geometric phases T0 to T4 of a subsection of the filter medium in section, wherein T4 again reaches position T0 after 360°.

The transport process is similar to the pulmonary process with fine dusts. The essential difference is that in the filter module according to the invention, although a particle-laden material mixture, in particular an aerosol, is conducted through a medium 2 as in the lung, it is not intermittently bidirectional, as in a bellows pump, but rather continuously unidirectional. This is enabled by the medium being periodically compressed, preferably in sine waves, wherein the movement migrates in a conveying direction (see FIG. 2).

In FIG. 1, the “in” inlet 7 is closed at timepoint T0. The inlet 7 opens over timepoint T1 by the rotation of the cover 5 to the maximum in T2. As of that point, it closes again over T3 to T4, which corresponds to the initial position T0. During the conveying process, the sine crest migrates in the conveying direction, wherein the path for the material mixture in the respective circular cylinder sectors 9 is closed at both low points by the compressed medium 2. In the intermediate phases, backflow from the not yet completely closed media 2 of the respective circular cylindrical sectors 9 is prevented by the cover 5. The entrapped material mixture is thus driven by the tapering cross section as in the alveoli when exhaling. All non-adhering particles here must pass through the entire medium 2 on the way to the outlet 8.

The “out” outlet 8 is likewise closed in T0. It opens over timepoint T1 to the maximum in T2, whereby the filtered material mixture is expelled. As of that point, it closes again over T3 to T4 with further expulsion, which here as well corresponds to the initial position T0.

FIG. 3 depicts a schematic, perspective progressive image of the pumping or respectively transport process of a material mixture for the circular cylinder sectors. A full compensation of force takes place in the prior art filter module depicted in FIGS. 1 to 3, so that the constant pumping action is produced solely by drive torque through a single helical deformation unit. This ensues with a plurality of the filter elements (circular cylinder sectors) shown in FIG. 1, which are permeable only at the inlet and at the outlet and arranged such that their outer peripheral surfaces form a hollow cylinder shell. The walls of the filter elements are impervious to prevent transverse flows.

The disadvantage here is that the individual filter elements are not only deformed in a single direction transverse to the conveying flow, but in two.

FIG. 4 shows movement patterns T0 to T4 for a single cylinder sector in the prior art filter module according to FIG. 1. It can be seen that two points of the cross section in the shape of a “layer cake slice” describe a circular path, whereby there is unnecessarily high flexure and thus a shorter service life as well as higher energy consumption to be expected.

FIG. 5 shows a perspective view of a filter module 10 according to the second design concept of the invention in five different states of deformation over the course of the periodic undulating deformation motion.

A constant pumping effect is thereby achieved by a plurality of filter elements 11 being arranged side by side and constantly being deformed out of phase with each other. It can be seen that sinewave forms not only result in the conveying direction but also transverse thereto. Taken as a whole, the sinusoidal wavefronts migrate diagonal to the conveying direction. Using a plurality of adjacent filter elements 11 is required so that no flow occurs transverse to the conveying direction. A particularly uniform pumping effect is to be expected with purely sinusoidal waves.

FIG. 6 shows (FIG. 6a in a vertical cross section through filter module 10 and FIG. 6b in a plan view of or respectively in a section through the deformation unit) how the sine fronts can be e.g. mechanically generated: To achieve the closest possible desired deformation, rollers 13 arranged on axes 14 disposed at low axial spacing from one another roll along the filter elements 11 in the conveying direction. The rollers 13 have different diameters so that they form the sine fronts on the contact surfaces to the filter elements 11 and run at individual speeds with little friction. The axes 14 with the rollers 13 can intermingle via a ribbed break in the contour and thus be arranged at the smallest possible axial spacing.

It is also possible for the diameter of a roller 13 to change along the axial extension of the roller 13 and the roller 13 be correspondingly longer. This is particularly useful in the small diameter range in which it is not necessary for the rollers 13 of adjacent axes 14 to intermingle. Such a roller 13 can in particular assume an at least partially substantially conical (roller 13a ) or double-conical (roller 13b ) form.

The filter elements 11 should have the length of a sine wave for pulsation-free conveyance.

Since the rollers 13 would shear the filter element 11 trapezoidally in the conveying direction, a rocker 15 is mounted on the “in” inlet side which holds the wall of the filter element 11 in position.

Vertically acting actuators distributed for example over the surface can also produce the deformations per any given drive principle. In this case, no rocker 15 would be required.

The axes 14 with the rollers 13 shown in FIG. 6 are subjected to load with each respective sinusoidal segment and loaded with tilting torque in the asymmetrical case. Furthermore, there is always a load transverse the conveying direction as the rollers 13 run obliquely to the wavefronts.

FIG. 7 shows how these two unwanted loads respectively compensate each other by the symmetrical arrangement of multiple filter elements 11 in a filter module 10: The force arrows for the radial loads Fᵣ depicted at the front corners have the same lever arm to the center, which cancels the tilting torques, and the roller axial loads Fₐ have opposite orientations. The wavefronts are illustrated by dashed/dotted lines and resemble a herringbone gearing pointing in the direction of conveyance.

Expedient with respect to the orientation of the wavefronts is the following flexible design to the tight walls 12 of the filter elements 11, corresponding to a bamboo roller blind:
High flexural rigidity should prevail parallel to the dashed/dotted lines, produced for example by rod-shaped inserts, so as to approximate as close as possible the straight fronts also between adjacent rollers 13.
High flexural elasticity should prevail transverse thereto so as to approximate as close as possible the sinusoidal shape.
The elongating of the wall 12 produced by the greater path length of the sine waves relative to the filter elements 11 can be compensated by pretensioning or folding in the undeformed state.
To avoid transverse thrust in the filter elements 11, their walls 12 are coupled to the environment, see the rocker 15 fixed at the “in” inlet in FIG. 6.

The force arrows for the radial loads Fᵣ incorporated into FIG. 7 have the same orientation and are thus cumulative.

FIG. 8 therefore shows an implementation of a filter module 10 according to the second design concept of the invention in which such compensation is realized by the uniform arrangement of at least two of the arrangements of filter elements 11 on a hollow cylinder shown in FIG. 7. For the purpose of pulsation-free conveyance in/out of inlets and outlets in1 to out3, at least one set more of axes 14 of a sine wave length than filter elements 11 should be used.

Here, however, the conveyance is tangential, as can be seen at the three marked locations in1 to out3, and not axial as in the prior art filter module. To homogenize the roll-over process, the walls 12 of the arrangements of filter elements 11 are coupled to the inlets and outlets in1 to out3.

Three arrangements of filter elements 11 and four sets of axes 14 are arranged in FIG. 8a such that all the deforming rollers 13 are pressed by a central roller 16. The drive at rotational speed n can directly ensue frictionally via the central roller 16 or positively via the axes 14 of the deforming rollers 13.

In FIG. 8b, the central roller 16 is replaced by the constant acting and same resultant forces Fᵣₑₛ₁ to Fᵣₑₛ₃ exerted by same on the arrangement of filter elements 11 and the drive torque T required to produce rotational speed n. It can be seen here that the force lines of action meet at one point and thus compensate.

This arrangement prevents the circular motions shown in FIG. 4: The filter medium 2 is in particular radially deformed and receives a minimal deformation component in the conveying direction, which is minimized with the length of the rocker 15. The arrangements of filter elements 11 can be connected hydraulically in series or in parallel and also contain different filter media, e.g. for the cascading of coarse to medium to fine filter media.

To take into account for smooth running of the arrangement from FIG. 8 is that the inlet and outlet surfaces of the arrangements of filter elements 11 should not be orthogonal to the flow direction since the impact of the rollers 13 generate mechanical shocks (see the sectional area marked M in FIG. 9). The oblique line marked H in the same place is likewise unsuited as the position of the inlet and outlet surfaces since maximum hydraulic pulsations occur in this case. An exemplary compromise is illustrated as sectional area marked L, the selection of which is expected to result in only slight mechanical and hydraulic irregularities.

FIG. 10 shows a further implementation of a filter module 10 according to the second design concept of the invention, wherein the deformation unit in this implementation deforms the walls connecting the filter elements.

Three adjacently arranged and connected filter elements 11 are depicted in FIG. 10. The arrows marked Q indicate the direction of flow of the material mixture to be filtered through the filter elements 10, wherein the inlet side is located on the left in the figure and the outlet side on the right.

The deformation unit comprises a series of spindle drives 18 with contact elements 17 configured as nuts which are connected at their outer surfaces to the walls 12 of the filter elements 11. The contact elements 17 are preferably bonded or welded to the walls 12 and/or positively connected to the walls 12 by a flat projection (not shown) being inserted at the respective contact element between two interconnected walls 12 of adjacent filter elements 11.

Each spindle drive 18 exhibits alternating sections of left and right threads which engage with corresponding left/right threads of the contact elements 17 such that adjacent contact elements 17 move in opposite directions upon a rotation of the spindle drive 18.

The spindle drives 18 are preferably arranged substantially parallel and equidistant from one another substantially perpendicular to the longitudinal extension of the filter elements 11 and over the entire longitudinal extension of the filter elements 11. Only three spindle drives 18 are depicted in FIG. 10 while the positions of the contact elements of the other (not shown) spindle drives are indicated by circles.

Each spindle drive 18 is connected at one end to the shaft of a motor 19 and can be rotated by same in both directions. By appropriately controlling the motors 19, the respective contact elements 17, which contact the same two connected walls 12 of adjacent filter elements 11, can be set into an undulating, preferably sinusoidal movement. The desired periodic deformation motions of the filter elements 11 are generated by the contact elements 17 exerting a corresponding pressure or tension on the walls 12.

In FIG. 10, the outer walls of the outward filter elements 11 are not deformed. Of course, however, further contact elements 17 connected to said outer walls can be provided on the spindle drives 18 in order to deform them in a periodic manner.

Due to the respective opposite movements of the adjacent contact elements 17 on the spindle drives 18, the movements of adjacent filter elements 11 in FIG. 10 are out of phase with each other. The phase offset thereby amounts to 180 degrees; i.e. while one filter element 11 is compressed, the adjacent or the two adjacent filter elements 11 is/are expanded and vice versa.

Values other than 180 degrees can be achieved for the phase offset by way of a (not shown) mechanism with which adjacent contact elements 17 can be moved independently of one another. To that end, each spindle drive 18 is preferably provided with a continuous thread of the same orientation (left or right thread) and the spindle drives 18 are not rotatably mounted. In contrast, each contact element 17 comprises a nut movable relative to the housing of the contact element 17 which engages with the spindle drive 18. In addition, each contact element 17 is provided with its own drive for rotating the nut, whereby the contact element 17 moves on the spindle drive 18. With appropriate control, which preferably ensues wirelessly, all the contact elements 17 can then move independently of each other on the spindle drives 18, whereby any given phase-shifted deformation motions can be realized.

In the implementation of the invention according to FIG. 10, the deformation motions act on the filter elements 11 in that direction in which the filter elements 11 are arranged side by side. The filter elements 11 therefore do not need any deflection space perpendicular to that direction during their deformation. This yields the advantage of almost completely filling the available space.

3o Furthermore, several layers of adjacently arranged and connected filter elements 11 can be “stacked” one atop the other, whereby only the spindle drives 18 need to be led through in between the layers. In this case as well, the available space is almost completely filled.

### LIST OF REFERENCE NUMERALS

1 housing
2 medium
3 shell
4 shaft
5 cover
6 eccentric
7 inlet
8 outlet
9 circular cylinder sector
T0-T4 timepoints (T4=TO)
A0-A4 axial positions (A4=A0)
Δn rotational speed
10 filter module
11 filter element
12 wall
13 roller
13a conical roller
13b double-conical roller
14 axis
15 rocker
16 central roller
17 contact element
18 spindle drive
19 motor

What is claimed is,:

1. A filter module having a substantially cylindrical housing, into which is introduced:
a substantially cylindrically shaped cylindrical open-pored medium which is designed to hold a material mixture;
at least one deformation unit, wherein the cylindrical open-pored medium is geometrically deformable by the at least one deformation unit at least along the cylinder axis of the substantially cylindrical housing or in the radial direction; and
at least one inlet and at least one outlet for the material mixture.

2. The filter module according to claim 1, wherein the at least one deformation unit is movable relative to the housing and the cylindrical open-pored medium.

3. The filter module according to claim 2, wherein in a relative movement, the at least one deformation unit is at rest and the housing and the cyclindrical open-pored medium move or that the housing and the cylindrical open-pored medium are at rest and the at least one deformation unit moves.

4. The filter module according to claim 1, wherein the cylindrical open-pored medium forms at least two cylinder sectors.

5. The filter module according to claim 4, wherein adjacent cylinder sectors are sealed against each other with respect to the material mixture.

6. The filter module according to claim 1, wherein the at least one inlet and/or the at least one outlet is set in a cover of the housing, wherein the cover is able to be coupled to the at least one deformation unit.

7. The filter module according to claim 1, wherein the at least one deformation unit has a helical geometry which is configured to act in a deforming manner on the cylindrical open-pored medium and thereby move the material mixture through the medium, into the medium, and/or out of the medium.

8. The filter module according to claim 7, wherein the at least one deformation unit is a shaft, a screw, or a hose body, or the at least one deformation unit comprises at least one eccentric.

9. The filter module according to claim 1, wherein the cylindrical open-pored medium is at least one of elastic and compressible.

10. The filter module according to claim 1, wherein the in the cylindrical open-pored medium is a substrate or a gel.

11. A method for binding particles of a material mixture in at least one medium using a filter module according to claim 1, wherein at least the following steps occur:
a. providing the material mixture at one of the inlets of the housing;
b. drawing in the material mixture by means of the at least one deformation unit being moved relative to the housing and the medium;
c. binding the particles in the medium;
d. pumping out the material mixture at least partially freed of particles at one of the outlets;
e. terminating or continuing with step f;
f. replacing the medium with another medium; and
g. continuing with step a.

12. A filter module system comprising at least two filter modules according to claim 1, wherein a first filter module and a second filter module in the at least two filter modules are connected in series such that one outlet of the first filter module is connected to an inlet of the second filter module in a releaseable, force-conveying,, and material mixture-conveying manner.

13. A method for binding particles of a material mixture in at least one medium using a filter module system according to claim 12, wherein at least the following steps occur:
a. providing the material mixture at an inlet of the first filter module;
b. pumping out the material mixture from the first filter module at the one outlet and drawing in the material mixture into the second filter module at the inlet by means of the at least one deformation unit or the covers of the first and second filter modules being jointly moved relative to the housing and the medium the respective filter module;
c. binding the particles in the first and second filter modules in their respective medium;
d. pumping out the material mixture at least partially freed of particles at an outlet of a last filter module;
e. terminating or continuing with step f;
f replacing the medium in at least one filter module with another medium;
g. continuing with step a.

14. A filter module for binding particles from a particle-laden material mixture comprising:
a plurality of filter elements, wherein each filter element is filled with an open-pored medium and surrounded by a wall impermeable to the material mixture and to the open-pored medium and having at least one inlet and at least one outlet for the material mixture, wherein the material mixture can flow through each filter element in the direction of its longitudinal extension from the at least one inlet to the at least one outlet, and
a deformation unit, wherein the filter elements and the open-pored medium are deformable by the deformation unit,
wherein the filter elements are arranged side by side with respect to their longitudinal extension, and wherein respectively adjacent filter elements are connected to each other along their respective facing walls running substantially parallel to their longitudinal extension,
wherein the deformation unit is designed to deform the filter elements with respect to their longitudinal extension periodically, and wherein deformation motions of the filter elements are phase-shifted relative each other.

15. The filter module according to claim 14, wherein the deformation motions of the filter elements are phase-shifted relative each other such that a periodic deformation motion results on the adjacently arranged filter elements along a series of locations at the same height with respect to the longitudinal extension of the filter elements.

16. The filter module according to claim 14, wherein at least one inlet or at least one outlet on a surface of at least one filter element exhibits an elongated shape with a longitudinal or transverse extension in a direction between a direction running transverse to the longitudinal extension of the filter element and a wavefront propagation direction.

17. The filter module according to claim 14, wherein the filter module further comprises at least one securing device by means of which the parts of the walls of the filter elements in an area of the inlets of the filter elements are fixable with respect to at least one stationary point external of the filter module.

18. The filter module according to claim 14, wherein the deformation unit comprises a plurality of rollers with at least partially different diameters which are configured to roll along the filter elements along the longitudinal extension of said filter elements and thereby deform the filter elements to at least partially different degrees of deformation.

19. The filter module according to claim 18, wherein the plurality of rollers is arranged on a plurality of parallel axes.

20. The filter module according to claim 19, wherein a first axis and a second axis adjacent to said first axis are arranged parallel to one another, and that for a pair comprising a first roller arranged on the first axis and a second roller directly adjacent to the first roller and arranged on the second axis, the distance separating the two axes is less than the sum of a radius of the first roller and a radius of the second roller.

21. The filter module according to claim 14, wherein the plurality of filter elements is arranged in a hollow cylindrical shape.

22. The filter module according to claim 21, wherein the deformation unit has a hollow cylindrical shape, wherein the deformation unit contacts the plurality of filter elements on their inner or outer sides, and wherein the filter elements and the deformation unit are configured to rotate relative to one another.

23. The filter module according to claim 22, wherein the filter module has at least two filter elements arranged one behind the other with respect to their longitudinal extension, wherein a first number of filter elements are arranged side by side with respect to their longitudinal extension in an axial direction of the hollow cylindrical shape in which the filter elements are arranged and a second number of filter elements are arranged one behind the other with respect to their longitudinal extension in a circumferential direction of the hollow cylindrical shape, and that the at least two filter elements are connected together along the respective parts of their walls extending transversely to their longitudinal extension and facing one another.

24. The filter module according to claim 23, wherein the number of periods of a periodic deformation of the filter elements greater with respect to their longitudinal extension by way of the deformation unit during a rotation of the deformation unit relative to the filter elements, than the number of hollow cylindrical filter elements arranged one behind the other with respect to their longitudinal extension.

25. The filter module according to claim 18, wherein the deformation unit contacts an inner side of the plurality of filter elements and a central roller is arranged on an inner side of the deformation unit which is designed to frictionally press at least one roller on each respective axis outward to the filter elements.

26. The filter module according to claim 14, wherein the deformation unit is configured to deform at least one part of the walls of the filter elements running substantially parallel to the longitudinal extension of the filter elements along which two adjacent filter elements are connected together.

27. A method for binding particles from a particle-laden material mixture with a filter module according to claim 14, wherein the material mixture is provided at least at one inlet of at least one filter element of the filter module, the open-pored medium in the filter element is deformed by the deformation unit, the material mixture is drawn into the filter element at the inlet, the material mixture flows through the filter element substantially in the direction of its longitudinal extension from the inlet to an outlet, wherein particles from the material mixture are bound in the medium and the material mixture is at least partially freed of particles pumped out at the outlet.
